(19) United States
(12) Patent Application Publication
(10) Pub. No.: US 2022/0151862 A1
(43) Pub. Date: May 19, 2022

(54) VIDEO CYCLIC SEXUAL MOVEMENT DETECTION AND SYNCHRONISATION APPARATUS

(71) Applicants: Andrew James SMITH, Hong Kong (HK); James David PROCTOR, Hong Kong (HK)

(72) Inventors: Andrew James SMITH, Hong Kong (HK); James David PROCTOR, Hong Kong (HK)

(21) Appl. No.: 17/439,145

(22) PCT Filed: Mar. 16, 2020
(86) PCT No.: PCT/EP2020/057163

§ 371 Date: Sep. 14, 2021

(30) Foreign Application Priority Data
Mar. 14, 2019 (GB) 1903509.6

(51) Int. Cl. A61H 19/00; G06V 40/10; G06V 40/20; G11B 27/10; H04N 21/422; H04N 21/43; H04N 21/442; H04N 21/478

(52) U.S. Cl. CPC A61H 19/30; G06V 40/107; G06V 40/20; G11B 27/10; H04N 21/42206; A61H 2201/5005; H04N 21/43079; H04N 21/44231; H04N 21/4781; A61H 19/44; A61H 2201/501; H04N 21/43076

(57) ABSTRACT

Video cyclic sexual movement detection and synchronisation apparatus (10) includes a selector (12), an analyser (14) and a output generator (16). In use, the apparatus (10) receives an input signal (18) which comprises a sequence (94) of video frames (20), each frame (20) comprising a plurality of image areas (22). In a selection phase, the selector (12) selects one of the image areas (22) as a subject area (24) and another of the image areas (22) as a reference area 26. In an analysis phase, the analyser (14) analyses a set (28) of the video frames (20) to determine a subject speed parameter (30) which relates to the speed of movement of the subject area (24) relative to the reference area (26). In a synchronisation phase, the output generator (16) generates an output signal (38) which comprises a speed signal (40) which is dependent on the subject speed parameter (30).

### BACKGROUND OF THE INVENTION

### 1. Field of the Invention

The present invention relates to video cyclic sexual movement detection and synchronisation apparatus particularly but not exclusively for detecting cyclic movement in video sequences and synchronising the movement of an object thereto.

### 2. The Prior Art

Conventionally, it is known to provide apparatus which can sense movement and respond thereto. However, commonly, the apparatus includes a tag which is attached to the moving part, which provides a target for the apparatus to follow. However in some situations it is not possible to attach a tag to the moving part, for example if the moving part is remote from the apparatus and is being viewed via a video link, or is not live and is being viewed on a video recording.

One known conventional method is for a pre-recorded video to be analysed by a human programmer. The programmer manually programs a synchronisation signal for activating an object such as a sex toy. The signal links movements in the video to movements of the object. In use, a user views the video and the object moves in synchronisation with the movements in the video. However, this method is time consuming and expensive as each video has to be analysed, and it is dependent on the skill of the operator. It requires correct synchronisation on playback, and cannot be employed for live video.

In this specification, the term “video sequence” is used to mean a sequence of video frames, each frame comprising a still image.

### SUMMARY OF THE INVENTION

According to a first aspect of the present invention, there is provided video cyclic sexual movement detection and synchronisation apparatus for detecting cyclic movement in video sequences and synchronising thereto, the apparatus including a selector, an analyser and an output generator, whereby, in use, the apparatus receives an input signal which comprises a video sequence of video frames, each frame comprising a plurality of image areas,

whereby, in a selection phase, the selector selects one of the image areas as a subject area and another of the image areas as a reference area, wherein, in the video sequence, the subject area moves relative to the reference area;

in an analysis phase, the analyser analyses a set of the video frames to determine a subject speed parameter which relates to the speed of movement of the subject area relative to the reference area;

in a synchronisation phase, the output generator generates an output signal which comprises a speed signal which is dependent on the subject speed parameter.

Possibly, the analyser analyses the set of video frames to determine a subject direction parameter which relates to the direction of movement of the subject area relative to the reference area.

Possibly, the output signal comprises a direction signal which is dependent on the subject direction parameter.

Possibly, the speed signal and the direction signal are combined to form a combined speed and direction signal, which may be dependent on the subject speed parameter and the subject direction parameter.

Possibly, the output signal is provided to an object, which may include a drive arrangement. Possibly, in use, the drive arrangement moves at least a part of the object, possibly the whole object, in response to the output signal.

Possibly, the speed of movement of the object part is dependent on the speed signal. Possibly, the direction of movement of the object part is dependent on the direction signal.

Possibly, the object is a human sexual stimulation device, such as a sex toy, and may be a vibratory sex toy.

Possibly, the object comprises part of the apparatus.

Possibly, the selector comprises a user operable selection device. Possibly, in the selection phase, the user operates the selection device to select the subject area and may operate the selection device to select the reference area.

Possibly, in the selection phase, the user views a portion or all of the video frames, and operates the selection device.

Alternatively, the selector may select the subject area according to a predetermined selection criterion set. Possibly, the selector includes a comparator, which evaluates each image area relative to the predetermined selection criterion set and selects a matching image area. Possibly, if there is no matching image area, the comparator provides an error message. Possibly, the matching image area comprises the subject area.

Possibly, the predetermined selection criterion set includes a movement criterion, which may select one or more moving image areas from non-moving image areas of the video sequence.

Possibly, the predetermined selection criterion set includes a cyclic characteristic criterion. Possibly, the matching image area is a cyclic movement area, which may move in a cyclic movement relative to the reference area.

Possibly, the cyclic movement includes:

an outward movement component in a first direction relative to the reference area; and

a subsequent return movement component in a second direction relative to the reference area, the second direction being an opposite direction to the first direction.

Possibly, the cyclic movement is an oscillatory movement, a reciprocating movement and/or a circulatory movement.

Possibly, the predetermined selection criterion set includes a cycle rate range criterion, which may relate to a cycle rate, which may comprise a number range of cyclic movements per unit time.

Possibly, the cycle rate range criterion comprises a minimum value of 0.1 cyclic movements per second.

Possibly, the cycle rate range criterion comprises a maximum value of 10 cyclic movements per second.

Possibly, the movement of the object part is a cyclic movement and may be an oscillatory movement, a reciprocating movement and/or a circulatory movement. Possibly, the object cyclic movement has a cycle rate. Possibly, in use, in a synchronising condition, the object movement cycle rate is related to the subject area cycle rate and may be directly related to the subject area cycle rate.

Possibly, the apparatus includes a filter arrangement, which may filter out information. Possibly, the filter arrangement includes an audio filter, which may reduce the video sequence to video-only, without audio. Possibly, the filter arrangement includes a greyscale filter, which may reduce the video sequence to a greyscale video sequence.

Possibly, the filter arrangement includes a sampling filter, which may sample a portion of the video frames, possibly to provide the set of video frames. Possibly, the sampling filter is arranged so that the set comprises frames at a rate in the range of at least 1 frame per second, possibly no more than 10 frames per second, and optimally approximately 3 frames per second.

Possibly, the selector includes a reference area selector, which selects the reference area from the non-moving image areas.

Possibly, the input signal is provided via a telecommunications system, possibly via the internet or a TV network.

Possibly, the input signal comprises a live signal of contemporaneous activity. Possibly, the input signal is a pre-recorded signal of historic activity.

Possibly, the selector, the analyser and the output generator are located remote to the user and the output signal is provided to the user via a telecommunications system, possibly via the internet.

Possibly one, some or all of the selector, the analyser and the output generator are located local to the user, on an electronic device such as a TV, a PC, a tablet computer, or a mobile phone. Possibly, the device includes a display screen, for displaying the video sequence.

Possibly, the input signal is provided by a video input generator, which may comprise any one, some or all of the group containing a camera, a gaming device, gaming software and video generation software. The video generation software could include video content comprising 3D, animation and anime videos.

Possibly, the apparatus includes a signal path which may, in use, transmit the video sequence from the video input generator to the display screen. Possibly, as the user views the video sequence on the display screen, the movement of the object part is synchronised to the movement of the subject area part in the video sequence.

Possibly, the video sequence includes a set up video sequence, during which the apparatus is in a set up condition. Possibly, in the set up condition, the apparatus is in the selection phase or the analysis phase, but not the synchronisation phase.

Possibly, the set up video sequence includes video frames showing more than one cyclic movement, and optimally at least two cyclic movements.

Possibly, the video sequence includes a synchronising video sequence, during which the apparatus is in a synchronising condition. Possibly, in the synchronising condition, the apparatus is in the analysis phase and the synchronisation phase, but not the selection phase.

Possibly, the apparatus is cyclic movement in video detection and synchronisation apparatus.

According to a second aspect of the present invention, there is provided a method of detecting cyclic sexual movement in video sequences and synchronising thereto, the method including providing video cyclic sexual movement detection and synchronisation apparatus, the apparatus including a selector, an analyser and a output generator, whereby in use the apparatus receives an input signal which comprises a video sequence of video frames, each frame comprising a plurality of image areas,

whereby, in a selection phase, the selector selects one of the image areas as a subject area and another of the image areas as a reference area, wherein, in the video sequence, the subject area moves relative to the reference area;

in an analysis phase, the analyser analyses a set of the video frames to determine a subject speed parameter which relates to the speed of movement of the subject area relative to the reference area;

in a synchronisation phase, the output generator generates an output signal which comprises a speed signal which is dependent on the subject speed parameter.

According to a third aspect of the present invention, there is provided a system for detecting cyclic sexual movement in video sequences and synchronising thereto, the system including video cyclic sexual movement detection and synchronisation apparatus, the apparatus including a selector, an analyser and a output generator, whereby in use the apparatus receives an input signal which comprises a video sequence of video frames, each frame comprising a plurality of image areas,

whereby, in a selection phase, the selector selects one of the image areas as a subject area and another of the image areas as a reference area, wherein, in the video sequence, the subject area moves relative to the reference area;

in an analysis phase, the analyser analyses a set of the video frames to determine a subject speed parameter which relates to the speed of movement of the subject area relative to the reference area;

in a synchronisation phase, the output generator generates an output signal which comprises a speed signal which is dependent on the subject speed parameter.

Possibly, the system includes any one, some or all of the group containing the video input generator, an uploading device, a telecommunications system, a server and the electronic device.

The uploading device may comprise an electronic device.

The electronic device may comprise a TV, a PC, a tablet, a mobile telephone or similar.

According to a fourth aspect of the present invention, there is provided computer readable media storing program instructions for detecting cyclic sexual movement in video sequences and synchronising thereto, the instructions including video cyclic sexual movement detection and synchronisation apparatus, the apparatus including a selector, an analyser and a output generator, whereby in use the apparatus receives an input signal which comprises a video sequence of video frames, each frame comprising a plurality of image areas,

whereby, in a selection phase, the selector selects one of the image areas as a subject area and another of the image areas as a reference area, wherein, in the video sequence, the subject area moves relative to the reference area;

in an analysis phase, the analyser analyses a set of the video frames to determine a subject speed parameter which relates to the speed of movement of the subject area relative to the reference area;

in a synchronisation phase, the output generator generates an output signal which comprises a speed signal which is dependent on the subject speed parameter.

Possibly, the apparatus includes any of the features described in any of the preceding statements or following description. Possibly, the method includes any of the steps described in any of the preceding statements or following description.

### BRIEF DESCRIPTION OF THE DRAWINGS

Embodiments of the present invention will now be described, by way of example only, and with reference to the accompanying drawings, in which:

FIG. 1 is a block diagram showing a first part of a method of operation of a video cyclic sexual movement detection and synchronisation apparatus, comprising a filtering phase;

FIG. 2 is a block diagram showing a second part of the method of operation of the apparatus, comprising a selection phase;

FIG. 3 is a block diagram showing a third part of the method of operation of the apparatus, comprising an analysis phase and a synchronisation phase;

FIGS. 4A to 4E are schematic diagrams of a first embodiment of the apparatus in use, with FIG. 4A showing a subject person waving a subject arm; FIG. 4B showing a system for detecting cyclic movement in video sequences and synchronising thereto, including the apparatus; FIG. 4C showing movement of an object corresponding to the movement of the subject arm; FIG. 4D is a sequence of velocity vector diagrams showing the speed and direction of movement of a subject area between video frames in the video sequence of FIG. 4E, and FIG. 4E is a schematic diagram of a video sequence of the first embodiment, with the frames shown corresponding to the movement of the subject arm in FIG. 4A;

FIG. 5A is a diagrammatic representation of another object comprising a motor, a connection arrangement and a moving part, with box 5A1 showing pictorially one mode of operation and box 5A2 showing another possible mode of operation;

FIG. 5B is a diagrammatic representation of yet another object comprising a motor and a moving part, with box 5B1 showing pictorially a possible mode of operation;

FIG. 6 is a schematic diagram showing the video sequence and the movement of the object part of the first embodiment shown in FIGS. 1 to 4.

In the drawings, where multiple instances of the same or similar features exist, only a representative one or some of the instances of the features have been provided with numeric references for clarity.

### DETAILED DESCRIPTION OF THE PREFERRED EMBODIMENTS

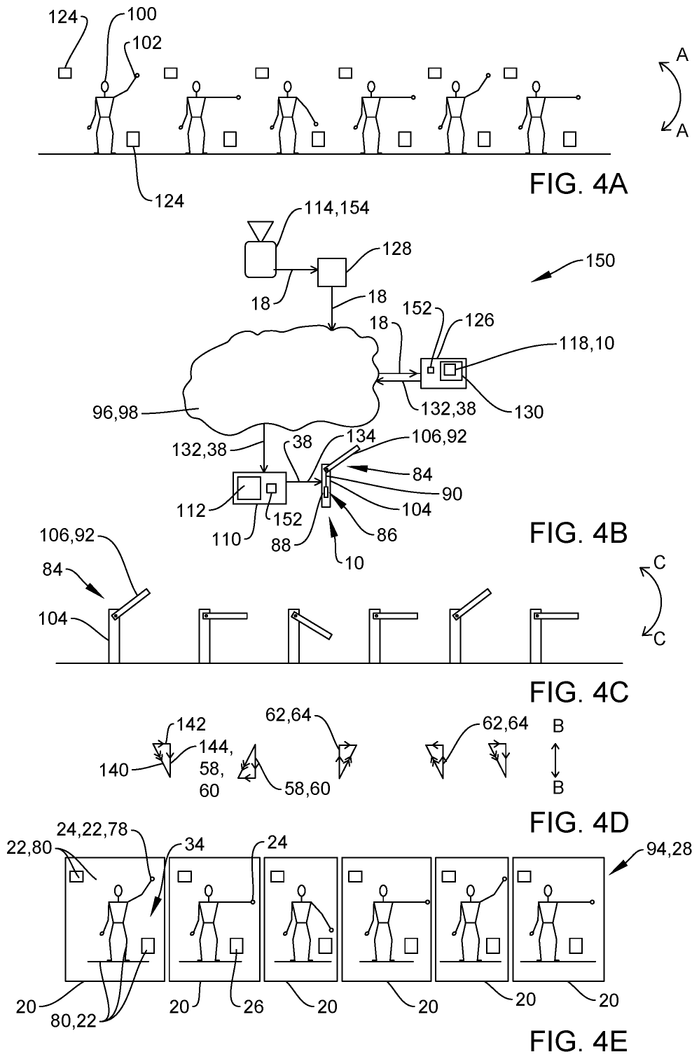

FIG. 4B shows a system 150 for system for detecting cyclic sexual movement in video sequences and synchronising thereto, the system 150 including video cyclic sexual movement detection and synchronisation apparatus 10.

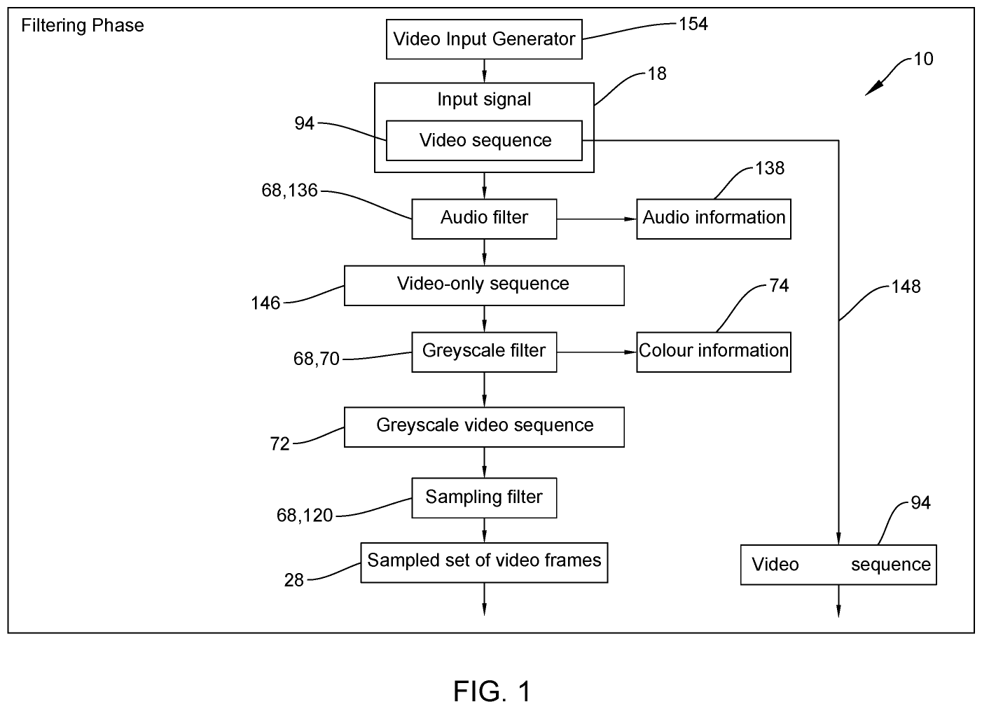

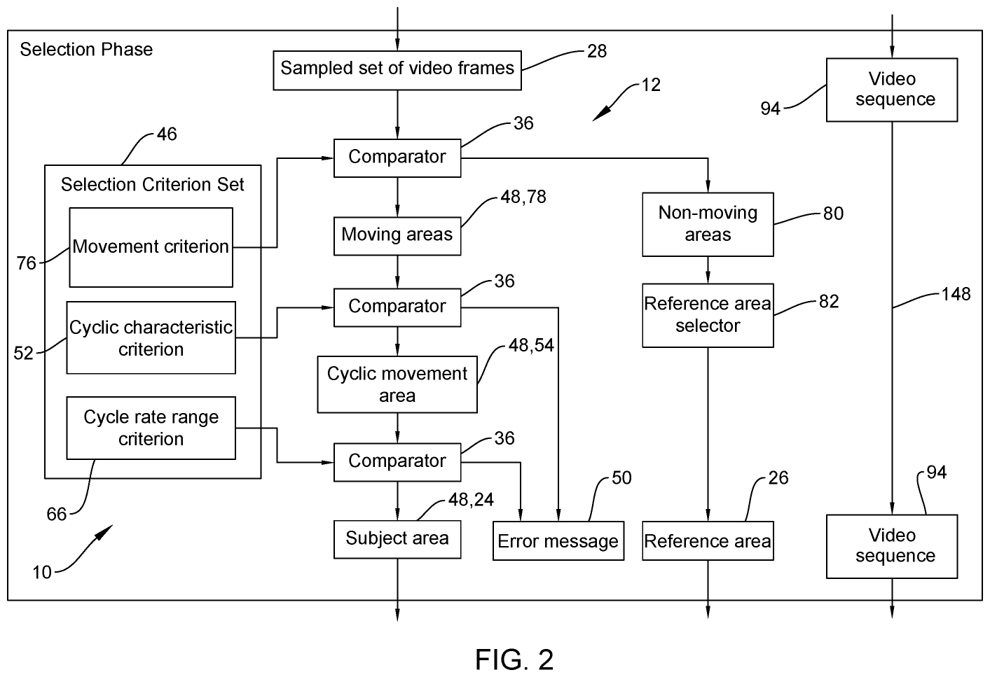

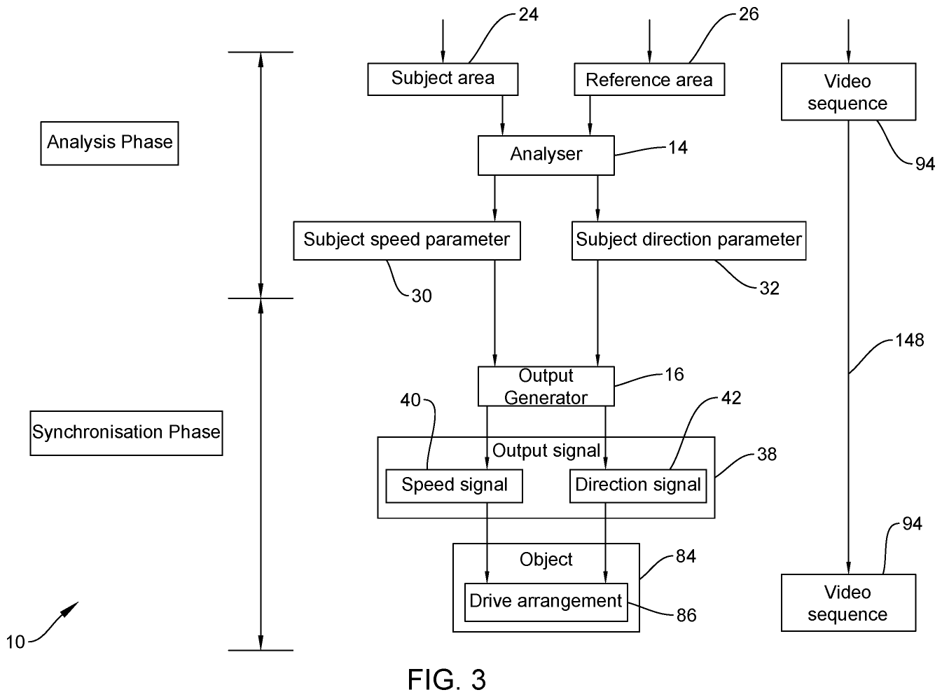

FIGS. 1 to 4 and FIG. 6 show the video cyclic sexual movement detection and synchronisation apparatus 10 for detecting cyclic movement in video sequences and synchronising thereto. The apparatus 10 includes a selector 12, an analyser 14 and a output generator 16.

In use, the apparatus 10 receives an input signal 18 which comprises a sequence 94 of video frames 20, each frame 20 comprising a plurality of image areas 22.

In a selection phase, the selector 12 selects one of the image areas 22 as a subject area 24 and another of the image areas 22 as a reference area 26.

In an analysis phase, the analyser 14 analyses a set 28 of the video frames 20 to determine a subject speed parameter 30 which relates to the speed of movement of the subject area 24 relative to the reference area 26.

In a synchronisation phase, the output generator 16 generates an output signal 38 which comprises a speed signal 40 which is dependent on the subject speed parameter 30.

The output signal 38 is provided to an object 84, which includes a drive arrangement 86, which moves at least a part 92 of the object 84, in response to the output signal 38. The speed of movement of the object part 92 is dependent on the speed signal 40 as will be described more fully below.

The input signal 18 is provided by a video input generator 154. Referring to FIGS. 4A to 4E, the video input generator 154 comprises a camera 114. The camera 114 records the video sequence 94 of a subject person 100 waving a subject part, comprising an arm 102, with two stationary objects 124 in the frames 20. The camera 114 transfers the video sequence 94 as or comprising part of the input signal 18 via a telecommunications network 96 (eg, the internet 98) to a remote server 126 via an uploading device 128 which could be a PC, tablet, mobile phone or other electronic device.

The apparatus 10 includes a filter arrangement 68, which, in use, in a filtering phase, filters out information from the video sequence 94. This reduces the amount of information to be processed, reducing the amount of processing and thus the processing power and/or time required.

In one example, the filter arrangement 68, the selector 12, the analyser 14 and the output generator 16 comprise one or more sets of instructions 118, which could be located on storage media 130. In the example shown, the storage media 130 with the set of instructions 118 is located on the remote server 126. The storage media 130 is computer readable and could comprise a disk, a hard drive, a memory stick, flash memory or similar.

In the example shown, the filter arrangement 68 includes an audio filter 136, which reduces each of the video frames 20 to a video-only (ie visual only) frame sequence 146, discarding audio information 138.

In the example shown, the filter arrangement 68 includes a greyscale filter 70, which reduces each of the video frames 20 to a greyscale video sequence 72, discarding colour information 74.

In the example shown, the filter arrangement 68 includes a sampling filter 120, which samples a portion of the video frames 20. For example, the sampling filter 120 could sample one frame 20 in every ten frames. For a 30 frames per second video sequence this would provide three frames per second. The sampled sequence comprises the set 28 of frames 20 to be analysed further.

The sampling filter 120 could be arranged so that the set 28 comprises frames which have been sampled at a rate in the range of 1 frame per second to 10 frames per second, and optimally approximately 3 frames per second.

In other examples, the video frames 20 could be unsampled, so that the filter arrangement 68 does not include a sampling filter 120.

The selector 12 includes a reference area selector 82, which selects the reference area 26 from the non-moving image areas 80.

The selector 12 selects the subject area 24 according to a predetermined selection criterion set 46. The selector 12 includes a comparator 36, which evaluates each image area 22 relative to the predetermined selection criterion set 46 and selects a matching image area 48. The matching image area 48 then comprises the subject area 24.

If there is no matching image area 48, the comparator 36 provides an error message 50.

In the example shown, the predetermined selection criterion set 46 includes a movement criterion 76, which selects one or more moving image areas 78 from non-moving image areas 80 of the video frame set 28.

In the example shown, the moving image areas 78 include the arm 102. The non-moving image areas 80 include the stationary objects 124 (which could be furniture, windows or the like).

The selector 12 includes a reference area selector 82, which selects the reference area 26 from the non-moving image areas 80.

In some examples, there may be no apparent non-moving image areas 80. In such cases the reference area selector 82 could select an edge of the frames 20 as the reference area 26.

In other cases there may be a plurality of non-moving image areas 80. The reference area selector 82 could simply select any one of the non-moving image areas, or could include an iterative routine which tests each of the non-moving image areas 80 and selects the one which gives the best result.

In the example shown, the predetermined selection criterion set 46 includes a cyclic characteristic criterion 52. The matching image area 48 is a cyclic movement image area 54, which moves in a cyclic movement relative to the reference area 26.

Referring to FIG. 4D, the cyclic movement includes an outward movement component 58 in a first direction 60 relative to the reference area 26 and a subsequent return movement component 62 in a second direction 64 relative to the reference area 26, the second direction 64 being an opposite direction to the first direction 60.

In this instance, the terms “outward” and “return” are used with reference to the start location of the moving image area 80.

The purpose of the cyclic characteristic criterion 52 is to identify those moving image areas 78 which have a cyclic movement.

The predetermined selection criterion set 46 includes a cycle rate range criterion 66, which relates to a cycle rate, which comprises a number range of the cyclic movements per unit time.

In one example, the cycle rate range criterion 66 comprises a minimum value of 0.1 cyclic movements per second and possibly a maximum value of 10 cyclic movements per second.

The cycle rate range criterion 66 ensures that only those cyclic movement image areas 54 which fulfil the predetermined cycle rate range criterion 66 can be selected as the subject area 24. This excludes movements which are cyclic but not relevant to the synchronisation desired.

In the case that there are several cyclic movement image areas 54 which fulfil the cycle rate range criterion 66, additional criteria could be utilised. For example, one possible criterion could be that the cyclic movement image area 54 which is the closest to the midrange value of the cyclic rate range criterion 66 is selected.

In another example, an average cycle rate could be calculated for all of the cyclic movement image areas 54.

Alternatively, a random one of the cyclic movement image areas 54 which fulfil the cycle rate range criterion 66 could be selected. In the example shown, the subject area 24 could be refined to the end of the arm 102 (ie, the hand) which is the part which moves fastest and furthest relative to the reference area 26.

Thus, in the selection phase, the apparatus 10 selects the subject area 24 and the reference area 26.

As mentioned above, in the analysis phase, the analyser 14 analyses the set 28 of the video frames 20 to determine the subject speed parameter 30 which relates to the speed of movement of the subject area 24 relative to the reference area 26. In the example shown, the analyser 14 also analyses the set 28 of the video frames 20 to determine a subject direction parameter 32 which relates to the direction of movement of the subject area 24 relative to the reference area 26.

FIG. 4D shows velocity vector diagrams which show the speed and direction of movement of the subject area 24 between adjacent video frames 20 in the set 28 of video frames 20 of FIG. 4E. In these diagrams, a resultant vector 140 is indicated by a double arrow >> and X and Y vector components 142, 144 are indicated by a single arrow >. In each case the alignment of the vector line indicates the direction of movement of the subject area 24, and the length of the line indicates the speed of movement of the subject area 24 in the respective direction.

The applicant has realised that the speed and direction of the subject area 24 are dependent on the reference area 26 selected, but that by considering the vector components the analysis can be simplified. For example, in one cyclic movement of the arm 102, the X vector component 142 goes through two oscillation cycles, while the Y vector component 144 goes through one oscillation cycle. In this case, selecting the Y vector component 144 as the subject direction parameter 32 provides an accurate and simple way of characterising the movement of the arm 102. It will also be noted that the arm 102 moves at a greater speed in the direction of the Y vector component 144, which also makes the movement of the arm 102 over the same time period more pronounced and thus easier to analyse.

Thus, in the embodiment shown, the analyser 14 provides the subject speed parameter 30 and the subject direction parameter 32 to the output generator 16.

In the synchronisation phase, the output generator 16 generates the output signal 38 which in this embodiment comprises a speed signal 40 which is dependent on the subject speed parameter 30 and a direction signal 42 which is dependent on the subject direction parameter 32.

Referring again to FIGS. 4A to 4E, a server signal 132, which, in this example, comprises the output signal 38, is transmitted from the remote server 126 via the telecommunications network 96 to a local electronic device 110, which could be a TV, a computer, a tablet or a mobile phone, and includes a display screen 112. The device 110 includes a display screen 112, for displaying the video sequence 94.

In the example shown, the apparatus 10 includes the object 84. The electronic device 110 provides the output signal 38 to the object 84 via a connection 134 which could be wired or wireless, and could comprise, for example, a Bluetooth® wireless connection.

In the example shown, the object 84 is a signalling device comprising a body 104. The part 92 comprises a signalling arm 106, which is pivotally mounted to the body 104 and moved by the drive arrangement 86.

The drive arrangement 86 moves the signalling arm 106 in accordance with the speed signal 40 and the direction signal 42. The movement of the signalling arm 102 is a cyclic movement, having a cycle rate which is related to the cycle rate of the subject area 24.

Thus, the speed and direction of movement of the signalling arm 106 are dependent on the subject speed parameter 30 and the subject direction parameter 32. Simply put, the apparatus 10 is arranged so that as the subject arm 102 moves, the movement of the subject arm 102 is replicated by the signalling arm 106. As the subject arm 102 raises and lowers, so the signalling arm 106 raises and lowers.

Referring to FIG. 4A, arrows A show the cyclic movement of the subject part 102, which moves reciprocally along an arced path. Referring to FIG. 4D, arrows B show the cyclic movement after analysis by the analyser 14. Referring to FIG. 4C, arrows C show the movement of the object part 92, which moves reciprocally along an arced path. In other embodiments, the object part 92 could have a different cyclical movement.

The apparatus 10 could include a signal path 148 which transmits the video sequence 94 from the camera 114 to the display screen 112, so that as the user views the video sequence 94 on the display screen 112, the movement of the object part 92 is synchronised to the movement of the subject part 102 in the video sequence 94.

In another embodiment, the signal path 148 from the camera 114 to the display screen 112 is independent of the apparatus 10, but the movement of the object part 92 is substantially synchronised to the movement of the subject part 102 in the video sequence 94 because both movements occur in real time, the movement of the object part 92 being only slightly delayed by a processing time delay.

The apparatus 10 is specifically directed towards the detection of cyclic movement and synchronisation therewith. This provides the advantage that the filter arrangement 68, the selector 12, the analyser 14 and the output generator 16 can be optimised specifically towards this goal, increasing the efficiency of the apparatus 10.

In one example, the input signal 18 could comprise a live signal, with the video sequence 94 showing present (contemporaneous) activity in real time. In another example, the input signal 18 could comprise a pre-recorded signal, with the video sequence showing past (historic) activity. It is an advantage of the present invention that, unlike present arrangements, the invention can be employed with live video. A further advantage is that, unlike present arrangements, the invention can be employed with pre-recorded video without first requiring time-consuming and expensive human analysis.

Referring to FIG. 6, the video sequence 94 includes a set up video sequence 108, during which the apparatus 10 is in a set up condition. In the set up condition, the apparatus 10 progresses through the filtering phase, the selection phase and the analysis phase, to the synchronisation phase. In the set up condition, the object 84 does not receive the output signal 38 and does not move.

The set up video sequence 108 includes video frames 20 showing at least one single cycle video sequence 56 showing one cyclic movement, and optimally at least two single cycle video sequences 56.

The video sequence 94 includes an synchronising video sequence 116, during which the apparatus 10 is in a synchronising condition. The synchronising video sequence 116 directly follows the set up video sequence 108. In the synchronising condition, the apparatus 10 could be continuously receiving the input signal 18, and the apparatus 10 progresses through the filtering phase, the analysis phase and the synchronisation phase, but not the selection phase. In the synchronising condition, the movement of the object part 92 is continuously synchronised to the movement of the subject area 24.

In one particular embodiment of the apparatus 10, the object 84 is a human sexual stimulation device (not shown), such as a vibratory sex toy, which has a drive arrangement 86 which provides variable motive power to move the device or part of the device cyclically. The variable motive power could cause variation in the speed of movement (frequency), length (amplitude) and the direction of movement of the device or the device part. The apparatus 10 synchronises the speed and direction of movement of the device to a video sequence showing, for example, sexually stimulating content which comprises cyclic movement. The cyclic movement in the content could be an oscillatory movement, a reciprocating movement and/or a circulatory movement. The cyclic movement in the content could relate to, for example, movements including breathing, rubbing, stroking, massaging, rotating, squeezing, sucking, compressing, inflating, deflating, expanding, contracting etc.

Thus, in one example, the camera 114 records a video sequence of the content, which is transmitted via the internet 98 to the server 126, processed by the filter arrangement 68 and the selector 12 to identify the subject area 24 and the reference area 26, and further processed by the analyser 14 to determine the subject speed parameter 30 and the subject direction parameter 32. The output generator 16 provides the output signal 38 to the drive arrangement of the device, the movement of which is then synchronised to the movement in the video content.

Importantly, the movement of the object 84 is not synchronised to the audio of the input signal 18, which is often out of sync with the movement in the video sequence 94. Also, the audio often comprises copyright work which may require permission to reuse. In some embodiments, the output signal 38 could be used to generate an audio track for the user.

In one embodiment, the system 150 includes any one, some or all of the group containing the video input generator 154, the camera 114, the uploading device 128, the telecommunications system 96, the server 126 and the electronic device 110.

### Other Embodiments

A number of variations of the apparatus 10 are provided by the invention.

In other embodiments, the storage media 130 and the set or sets of instructions 118 could be located on any one or combination of the remote server 126 or the local electronic device 110. The server 126 and the electronic device 110 could each include a processor 152 for implementing the sets of instructions 118

In the embodiment described above, the storage media 130 with the sets of instructions 118 relating to the filter arrangement 68, the selector 12, the analyser 14 and the output generator 16 are located on the server 126 remote to the location of the user and the object 84, and the output signal 38 is provided from the server 126 to the user's electronic device 110 via the telecommunications system 96, eg the internet 98.

In another embodiment, the video input generator 154, the camera 114, the storage media 130, and the sets of instructions 118 relating to the filter arrangement 68, the selector 12, the analyser 14 and the output generator 16 could be located local to the user and the object 84, for example, on the electronic device 110. For example, the electronic device could comprise a mobile phone could include the camera 114, the storage media 130, and the sets of instructions 118 relating to the filter arrangement 68, the selector 12, the analyser 14 and the output generator 16. The mobile phone could then provide the output signal 38 to the object.

In a further embodiment, the camera 114 could record the video sequence 94 from a video recording.

In other embodiments, the video input generator 154, the camera 114, the storage media 130, and one or some of the sets of instructions 118 are located remote to the user and the storage media 130 and one or some of the sets of instructions 118 are located local to the user. For example, the sets of instructions 118 relating to the filter arrangement 68, the selector 12 and the analyser 14 could be located on the server 126 and the set of instructions 118 could be made separately available (eg for download to the electronic device 110) and specific to a particular type of object 84.

In these and other embodiments, the apparatus could include a plurality of different types of objects 84, each of which receives a bespoke output signal 38 suited to that type of object.

In one particular embodiment, the analyser 14 only determines the subject speed parameter 30. The subject speed parameter 30 could relate directly to the speed of movement of the subject area 24, or could relate to the cycle rate, or a combination of the speed of movement and the cycle rate. The output generator 16 only provides the speed signal 40 to the object 84. An example of such an object 84 is given below.

In another embodiment, the output generator 16 provides a combined speed and direction signal 44 to the object 84. The combined signal 44 is dependent on both the subject speed parameter 30 and the subject direction parameter 32. An example of such an object 84 is given below.

In another embodiment, the selector 12 comprises a user operable selection device 34 (see FIG. 4E) which could comprise, for example, a touch screen, or a computer mouse which controls a screen cursor. In the selection phase, the user views the set up sequence 108 of the video frames and operates the selection device 34 to select the subject area 24, and could operate the selection device 34 to select the reference area 26.

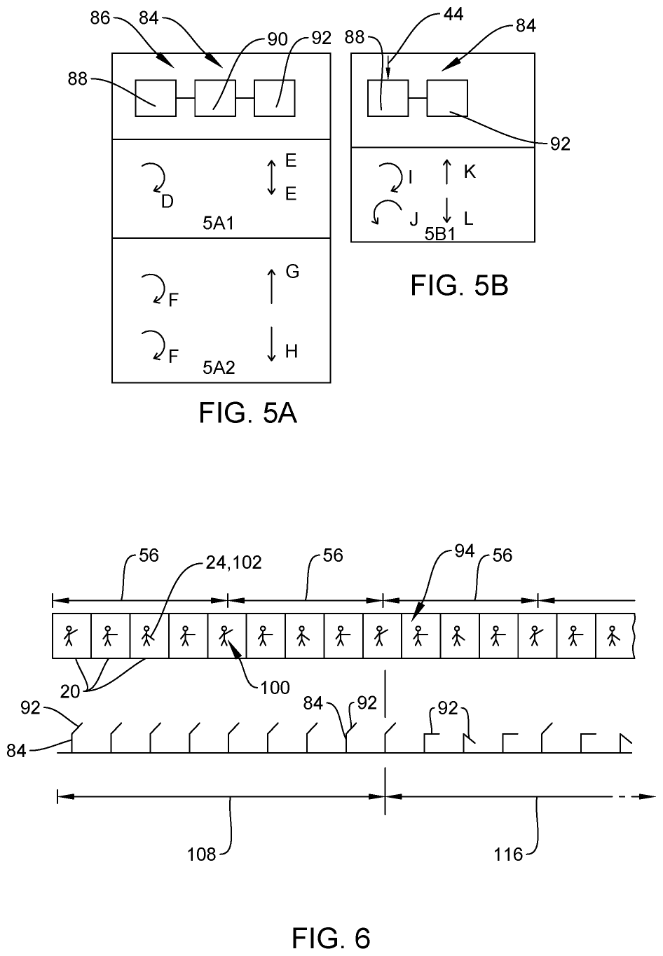

FIGS. 5A and 5B show other embodiments of the invention, many features of which are similar to those already described in relation to the embodiment of FIGS. 1 to 4. Therefore, for the sake of brevity, the following embodiments will only be described in so far as they differ from the embodiment already described. Where features are the same or similar, the same reference numerals have been used and the features will not be described again.

FIGS. 5A and 5B show, in conceptual form, different embodiments of the object 84.

In FIG. 5A, the object 84 comprises the drive arrangement 86 and the moving object part 92. The drive arrangement 86 comprises a motor 88 and a connection arrangement 90 (which could comprise, for example, a cam and cam follower device, or a reversible gear arrangement) which connects the motor 88 to the moving object part 92.

Box 5A1 shows one drive variant, in which the motor 88 rotates in just one direction (arrows D) and causes the moving object part 92 to move cyclically (arrows E) eg reciprocate, oscillate or vibrate. In this variant, as the speed of the motor 88 varies, the speed of the cyclical movement varies correspondingly. In this variant, the output signal 38 comprises only the speed signal 40, as mentioned above. In one example of this variant, the connection arrangement 90 comprises a cam and cam follower device which converts the motor rotation to reciprocating longitudinal movement.

Box 5A2 shows another drive variant, in which the motor 88 rotates in just one direction (arrows F) but the connection arrangement 90 (which could comprise a reversible gear arrangement) can be operated to reverse the direction of motion of the moving object part 92 (arrows G and H). The speed of the motor 88 can be varied and the direction of movement of the object part 92 is determined by the connection arrangement 90. In this variant, the output signal 38 comprises both the speed signal 40 and the direction signal 42.

In FIG. 5B and box 5B1, the object 84 comprises the drive arrangement 86 and the moving object part 92. The drive arrangement 86 comprises just the motor 88, which is reversible in rotational direction (arrows I and J) and directly drives the moving object part 92 so that the direction of motion of the object part 92 (arrows K and L) is dependent on the rotational direction of the motor 88. Thus the speed and direction of the motor 88 can be varied. In this variant, the output signal 38 comprises both the speed signal 40 and the direction signal 42 and could comprise the combined speed and direction signal 44.

### Other Modifications

Various other modifications could be made without departing from the scope of the invention. The various components could be of any suitable size and shape, and could be formed of any suitable material (within the scope of the specific definitions herein).

The apparatus could provide a reverse audio signal (not shown) from the user to the subject 100 to permit communication from the user to the subject 100.

The apparatus could include a user input signal (not shown) to control the playback of the pre-recorded video, for example, pause, change speed, stop, start.

The apparatus could be arranged to continue to provide the same output signal 38 to the object 84 while the playback is paused.

The apparatus could be arranged to continue to provide the same output signal 38 to the object 84 until a change in the cyclic rate is detected.

In one embodiment, the apparatus could include an object recogniser (not shown) which matches the subject area to a library of images and will only permit selection of those subject areas which match an image in the library.

The apparatus could include none, one, any or all of the filters described, and could include different filters to those described.

The apparatus could include none, one, any or all of the pre-determined selection criteria described, and could include different pre-determined selection criteria to those described.

In other embodiments, the video input generator 154 could comprise a gaming device, gaming software and/or video generation software. The video generation software could include video content comprising 3D, animation and anime videos. For example, in a multi-player internet game, the gaming software (not shown) could generate an input signal 18 comprising a game video sequence 94 of the movements of an avatar or character controlled by one of the players. The game video sequence 94 could be transmitted via the internet 98 to the server 126, processed by the filter arrangement 68 and the selector 12 to identify the subject area 24 and the reference area 26, and further processed by the analyser 14 to determine the subject speed parameter 30 and the subject direction parameter 32. The output generator 16 provides the output signal 38 to the drive arrangement of the object 84 the movement of which is then synchronised to the movement in the game video sequence 94. Thus, the invention enables two (or more) players in the multi-player internet game to remotely interact with each other in a real physical way as well as in a virtual way.

Any of the features or steps of any of the embodiments shown or described could be combined in any suitable way, within the scope of the overall disclosure of this document.

There is thus provided cyclic movement detection and synchronisation apparatus for detecting cyclic movement in video images and synchronising thereto. The apparatus has a number of advantages over conventional arrangements. In particular, the apparatus does not require subject areas in the video sequence to be tagged or previewed. The apparatus enables the synchronisation of the movement of an object with a moving subject area in online video content with no prior viewing of the video content and can be used with both live and pre-recorded video.

1. A video cyclic sexual movement detection and synchronisation apparatus for detecting cyclic sexual movement in video sequences and synchronising thereto, the apparatus including a selector, an analyser and an output generator, whereby, in use, the apparatus receives an input signal which comprises a video sequence of video frames, each frame comprising a plurality of image areas, whereby,
in a selection phase, the selector selects one of the image areas as a subject area and another of the image areas as a reference area, wherein, in the video sequence, the subject area moves relative to the reference area;
in an analysis phase, the analyser analyses a set of the video frames to determine a subject speed parameter which relates to the speed of movement of the subject area relative to the reference area; and
in a synchronisation phase, the output generator generates an output signal which comprises a speed signal which is dependent on the subject speed parameter.

2. The apparatus according to claim 1, in which the output signal is provided to an object, which includes a drive arrangement and wherein, in use, the drive arrangement moves at least a part of the object in response to the output signal, and in which the speed of movement of the object part is dependent on the speed signal.

3. The apparatus according to claim 1, in which the analyser analyses the set of video frames to determine a subject direction parameter which relates to the direction of movement of the subject area relative to the reference area, and the output signal comprises a direction signal which is dependent on the subject direction parameter.

4. The apparatus according to claim 3, in which the output signal is provided to an object, which includes a drive arrangement and wherein, in use, the drive arrangement moves at least a part of the object in response to the output signal, and in which the speed of movement of the object part is dependent on the speed signal and the direction of movement of the object part is dependent on the direction signal.

5-8. (canceled)

9. The apparatus according to claim 2, in which the object comprises part of the apparatus.

10. (canceled)

11. The apparatus according to claim 1, in which the selector selects the subject area according to a predetermined selection criterion set; the selector includes a comparator, which evaluates each image area relative to the predetermined selection criterion set and selects a matching image area; and in which the matching image area comprises the subject area.

12. The apparatus according to claim 11, in which the predetermined selection criterion set includes a movement criterion, which selects one or more moving image areas from non-moving image areas of the video sequence.

13. The apparatus according to claim 11, in which the predetermined selection criterion set includes a cyclic characteristic criterion, and the matching image area is a cyclic movement area, which moves in a cyclic movement relative to the reference area.

14. The apparatus according to claim 11, in which the predetermined selection criteria set includes a cyclic characteristic criterion, and the matching image area is a cyclic movement area, which moves in a cyclic movement relative to the reference area, and in which the cyclic movement includes:
an outward movement component in a first direction relative to the reference area; and a subsequent return movement component in a second direction relative to the reference area, the second direction being an opposite direction to the first direction.

15. The apparatus according to claim 11, in which the predetermined selection criterion set includes a cyclic characteristic criterion, and the matching image area is a cyclic movement area, which moves in a cyclic movement relative to the reference area, and in which the cyclic movement includes: and outward movement component in a first direction relative to the reference area; and a subsequent return movement component in a second direction relative to the reference area, the second direction being an opposite direction to the first direction; and in which the cyclic movement is an oscillatory movement, a reciprocating movement and/or a circulatory movement.

16. The apparatus according to claim 11, in which the predetermined selection criterion set includes a cycle rate range criterion, which relates to a subject area cycle rate, which comprises a number range of the cyclic movements per unit time.

17. The apparatus according to claim 11, in which the predetermined selection criterion set includes a cycle rate range criterion, which relates to a subject area cycle rate, which comprises a number range of the cyclic movement per unit time and in which the cycle rate range criterion comprises a minimum value of 0.1 cyclic movements per second.

18. The apparatus according to claim 11, in which the predetermined selection criterion set includes a cycle rate range criterion, which relates to a subject area cycle rate, which comprises a number range of the cyclic movements per unit time and in which the cycle rate range criterion comprises a maximum value of 10 cyclic movements per second.

19. The apparatus according to claim 3, in which:
the output signal is provided to an object, which includes a drive arrangement and wherein, in use, the drive arrangement moves at least part of the object in response to the output signal, and in which the speed of movement of the object part is dependent on the speed signal and the direction of movement of the object part is dependent on the direction signal;
the selector selects the subject area according to a predetermined selection criterion set the selector includes a comparator, which evaluates each image area relative to the predetermined selection criterion set and selects a matching image area; and in which the matching image area comprises the subject area;
the predetermined selection criterion set includes a cycle rate range criterion, which relates to a subject area cycle rate, which comprises a number range of the cyclic movements per unit time; and
in which the movement of the object part is a cyclic movement and may be an oscillatory movement, a reciprocating movement and/or a circulatory movement; the object cyclic movement has a cycle rate, and in which in use, in a synchronising condition, the object movement cycle rate is related to the subject area cycle rate and may be directly related to the subject area cycle rate.

20. The apparatus according to claim 1, in which the apparatus includes a filter arrangement, which filters out information; the filter arrangement includes an audio filter, which reduces the video sequence to video-only, without audio; and/or the filter arrangement includes a greyscale filter, which may reduce the video sequence to a greyscale video sequence.

21. The apparatus according to claim 1, in which the selector includes a reference area selector, which selects the reference area from the non-moving image areas.

22-24. (canceled)

25. The apparatus according to claim 1, in which the input signal is provided by a video input generator, which comprises any one, some or all of the group containing a camera, a gaming device, gaming software and video generation software; and in which the apparatus includes a signal path which, in use, transmits the video sequence from the video input generator to a display screen; and in which, as the user views the video sequence on the display screen, the movement of the object part is synchronised to the movement of the subject area in the video sequence.

26-27. (canceled)

28. The apparatus according to claim 1, in which the video sequence includes a set up video sequence, during which the apparatus is in a set up condition; and, in which, in the set up condition, the apparatus is in the selection phase or the analysis phase, but not the synchronisation phase.

29. The apparatus according to claim 28, in which the set up video sequence includes video frames showing more than one cyclic movement, and optimally at least two cyclic movements.

30. The apparatus according to claim 1, in which the video sequence includes a synchronising video sequence, during which the apparatus is in a synchronising condition; and, in which, in the synchronising condition, the apparatus is in the analysis phase and the synchronisation phase, but not the selection phase.

31-35. (canceled)
